(19) United States
(12) Patent Application Publication
(10) Pub. No.: US 2023/0303855 A1
(43) Pub. Date: Sep. 28, 2023

(54) COATING WITH IMPROVED SOLAR REFLECTANCE

(71) Applicant: SWIMC LLC, Cleveland, OH (US)

(72) Inventors: Kyle KINGSLEY, St. Michael, MN (US); Victoria J. GELLING, Medina, MN (US)

(21) Appl. No.: 18/041,509

(22) PCT Filed: Aug. 27, 2021
(86) PCT No.: PCT/US2021/047852

§ 371 Date: Feb. 13, 2023

Related U.S. Application Data
(60) Provisional application No. 62/706,601, filed on Aug. 27, 2020.

(51) Int. Cl. C09D 5/33; C09D 5/03; C09D 7/41; C09D 201/00

(52) U.S. Cl. CPC C09D 5/004; C09D 5/035; C09D 7/41; C09D 201/00

(57) ABSTRACT

The present description provides a single layer coating system applied on a substrate, wherein the coating system demonstrates increased total solar reflectance, and thereby prevents increase in temperature of one or more interior spaces defined by the substrate. The coating system described herein may be used as a “cool coating.” The coating compositions described herein use a combination of pigments that are reflective and transparent in the near infrared (NIR) region of the electromagnetic spectrum.

### BACKGROUND OF THE INVENTION

Polymer coating compositions are routinely applied to substrates, especially metal substrates. Such coatings are used for a variety of reasons, including, for example, to protect the substrate from degradation, to beautify the substrate (e.g., to provide color, brightness, etc.), and/or to reflect light and/or heat.

Many such polymer coating compositions are applied on planar substrates (e.g., using coil coating processes) that are subsequently formed into finished articles, including articles used as exterior building materials, such as for roofs, siding, and the like. The coating must maintain a suitable aesthetic appearance (gloss, color, and the like) over prolonged periods of exposure to various conditions, including light, humidity, rain, fluctuating temperatures, and the like.

Traditionally, dark colored coatings are used for roofs, siding, and other building materials. Such coatings tend to absorb energy in the near infrared (NIR) region of the electromagnetic spectrum. This absorption in the NIR region is converted to heat, which causes the temperature of interior spaces defined by roof or siding materials to increase. In urban areas, such buildings produce a “heat island effect” wherein the temperature increases to beyond ambient temperatures in the surrounding areas. This effect leads to thermal discomfort and large amounts of energy are required for cooling in air-conditioned buildings.

In order to combat this heat island effect, dark colored coatings with improved solar reflectance, known as “cool coatings,” are conventionally used for building materials in warmer climates. However, these cool coating systems are typically at least two layer coating systems where a dark colored coating is applied over a reflective, lighter colored basecoat. Multilayer coatings with multiple color requirements add complexity and cost to the coil application process. In the alternative, where a single layer coating is applied, the substrate must be reflective in order to increase total solar reflectance and provide the desired cooling effect, thus limiting the use of these coatings to just a few substrates.

From the foregoing, it will be appreciated that a cool coating composition or system is needed where a single-layer approach is used to minimize the amount of material used and the cost of the process. In addition, it will be appreciated that a cool coating composition or system that may be applied over any substrate is needed.

### SUMMARY

The present description provides a single layer coating system applied on a substrate, wherein the coating system demonstrates increased total solar reflectance, and thereby prevents increase in temperature of one or more interior spaces defined by the substrate. The coating system described herein may be used as a “cool coating.”

In an embodiment, the single layer coating system described herein is formed from a thermosetting coating composition that exhibits total solar reflectance (TSR) of at least about 30. The coating composition typically comprises a binder system, a crosslinking agent, and a dispersion comprising (a) at least one pigment that is reflective in the near-infrared (NIR) region and (b) at least one pigment that is transparent in the near-infrared region. The binder system preferably includes at least a first resin component, and optionally, one or more additional resin components. Preferably, the coating composition includes at least a film-forming amount of the binder system.

In another embodiment, a coating composition is described. The coating composition typically comprises a binder system, a crosslinking agent, and a dispersion comprising (a) at least one pigment that is reflective in the near-infrared (NIR) region and (b) at least one pigment that is transparent in the near-infrared region. The binder system preferably includes at least a first resin component, and optionally, one or more additional resin components. Preferably, the coating composition includes at least a film-forming amount of the binder system.

In yet another embodiment, a method for improving the total solar reflectance of a substrate is provided. The method includes the steps of providing a substrate and applying on the substrate a coating composition. The coating composition typically comprises a binder system, a crosslinking agent, and a dispersion comprising (a) at least one pigment that is reflective in the near-infrared (NIR) region and (b) at least one pigment that is transparent in the near-infrared region. The binder system preferably includes at least a first resin component, and optionally, one or more additional resin components. Preferably, the coating composition includes at least a film-forming amount of the binder system.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set forth in the accompanying drawings and the description below. Other features, objects, and advantages of the invention will be apparent from the description and drawings, and from the claims.

### SELECTED DEFINITIONS

Unless otherwise specified, the following terms as used herein have the meanings as provided below.

The term “component” refers to any compound that includes a particular feature or structure. Examples of components include compounds, monomers, oligomers, polymers, binder resins, crosslinkers, organic groups contained there.

The term “crosslinker” refers to a molecule capable of forming a covalent linkage between polymers or between two different regions of the same polymer.

The term “self-crosslinking,” when used in the context of a self-crosslinking polymer, refers to the capacity of a polymer to enter into a crosslinking reaction with itself and/or another molecule of the polymer, in the absence of an external crosslinker, to form a covalent linkage therebetween. Typically, this crosslinking reaction occurs through reaction of complimentary reactive functional groups present on the self-crosslinking polymer itself or two separate molecules of the self-crosslinking polymer.

The term “thermoplastic” refers to a material that melts and changes shape when sufficiently heated and hardens when sufficiently cooled. Such materials are typically capable of undergoing repeated melting and hardening without exhibiting appreciable chemical change. In contrast, a “thermoset” refers to a material that is crosslinked and does not “melt.”

Unless otherwise indicated, a reference to a “(meth)acrylate” compound (where “meth” is bracketed) is meant to include both acrylate and methacrylate compounds.

The term “polycarboxylic acid” includes both polycarboxylic acids and anhydrides thereof.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

As used herein, the term “topcoat” refers to the outer coating applied to a substrate, i.e. a coating applied either directly to a pre-treated or bare substrate, or a coating applied over a primer or other coating layer. With reference to the coil coating systems described herein, the topcoat is a pigmented outer coating, such as a dark pigmented coating, for example.

The term “infrared” or “IR” refers to that region of the electromagnetic spectrum that runs from the nominal red edge of the visible spectrum at 700 nm to the microwave region at 1 mm. As used herein, the term “near infrared” or “NIR” refers to that region of the infrared spectrum that is between 750 nm and 2500 nm. Regions of the electromagnetic region are not so clearly defined, however, and divisions within the various regions of the electromagnetic spectrum are imprecise, as the skilled artisan would appreciate.

The term “reflective,” when used with regard to pigments described herein, means a pigment that may absorb in the visible region to produce a particular color but reflects in the IR region, specifically in the near IR (NIR) region.

When used with regard to pigments described herein, the term “transparent” means a pigment that may absorb in the visible region to produce a particular color, but is transparent in the near IR (NIR) region, i.e. the pigment transmits light or radiation with little to no scattering in the NIR region.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description provides a single layer coating system applied on a substrate. The coating system is formed from a thermosetting coating composition that exhibits total solar reflectance (TSR) of at least about 30. The coating composition typically comprises a binder system, a crosslinking agent, and a dispersion comprising (a) at least one pigment that is reflective in the near-infrared (NIR) region and (b) at least one pigment that is transparent in the near-infrared region. The binder system preferably includes at least a first resin component, and optionally, one or more additional resin components. Preferably, the coating composition includes at least a film-forming amount of the binder system. Although coating compositions including a liquid carrier are presently preferred, it is contemplated that the composition described herein may have utility in other coating application techniques such as, for example, powder coating, extrusion, or lamination.

In an embodiment, the single layer coating system described herein includes a substrate with at least a first coating composition applied thereon and cured to form a coating on the substrate. In an embodiment, the first coating composition applied on the substrate is a liquid coating composition including one or more binder systems. The binder system preferably includes at least a first resin component. Thermoplastic materials are generally preferred for use as the resin component in coil coating applications. In a preferred aspect, the resin component includes at least one thermoplastic fluoropolymer, more preferably a polymer derived from at least one fluoroolefin. Suitable fluoroolefins include, without limitation, tetrafluoroethylene, vinylidene difluoride, fluoroethylene, fluoropropylene, and mixtures thereof. In an aspect, the fluoropolymers may include substituents such as, for example, halogen, hydroxyl group, vinyl groups, ether groups, and the like. Polyvinylidene fluoride (PVDF), fluoroethylene vinyl ether (FEVE), and mixtures or combinations thereof are preferred.

In an embodiment, the first coating composition may include one or more additional resin components. Suitable resins include, for example, acrylics, (meth)acrylates, polyester, polyurethane, epoxy, and the like. In a preferred aspect, the first composition includes one or more polymers derived from ethylenically unsaturated monomers. In an aspect, these monomers may be copolymerized with the fluoroolefin in the first coating composition. Suitable ethylenically unsaturated monomers include, for example, ethylene, propylene, isobutylene, styrene, vinyl chloride, vinylidene chloride, vinyl formate, vinyl acetate, vinyl propionate, vinyl butyrate, methyl (meth)acrylate, ethyl (meth)acrylate, (meth)acrylonitrile, N-butoxymethyl (meth)acrylamide, and the like. If the additional resin component is intended to provide thermosetting properties, monomers including crosslinking functionality in the form of —OH, —NCO, —COOH, —NH2, combinations or mixtures thereof, and the like may be used. In an aspect, acrylic monomers such as (meth)acrylic acid, methyl (meth)acrylate, ethyl (meth)acrylate, styrene, combinations or mixtures thereof, and the like are preferred.

Accordingly, in an embodiment, the first coating composition is a polyvinylidene fluoride (PVDF) or fluoroethylene vinyl ether (FEVE) in combination with an acrylic resin. In an aspect, the first composition preferably includes 20 to 90 wt %, more preferably 30 to 80 wt %, even more preferably 40 to 70 wt % of the fluoropolymer and preferably 10 to 80 wt %, more preferably 20 to 70 wt %, even more preferably 30 to 60 wt % of the acrylic resin. In a preferred aspect, the composition includes 70 wt % fluoropolymer to 30 wt % acrylic.

In another embodiment, the binder system described herein includes at least a first resin component that is preferably a polyester resin, more preferably a durable polyester resin. Suitable polyesters include, for example, resins formed by reaction of compounds having reactive functional groups such as, for example, compounds with hydroxyl, carboxyl, anhydride, acyl, or ester functional groups. Hydroxyl functional groups are known to react, under proper conditions, with acid, anhydride, acyl or ester functional groups to form a polyester linkage. Suitable compounds for use in forming the polyester resin include mono-, di-, and multi-functional compounds. Di-functional compounds are presently preferred. Suitable compounds include compounds having reactive functional groups of a single type (e.g., mono-, di-, or poly-functional alcohols or mono-, di-, or poly-functional acids) as well as compounds having two or more different types of functional groups (e.g., a compound having both an anhydride and an acid group, or a compound having both an alcohol and an acid group, etc.). The binder system may include one or more additional resin components that are the same as, or different from, the first resin component.

In an embodiment, the binder system may include a second polyester resin component in addition to the first resin component. For example, the second polyester resin component may be a silicone-modified or siliconized polyester resin. Suitable siliconized polyesters include those formed by the reaction of silicone-functional compounds with compounds having other reactive functional groups such as, for example, compounds with hydroxyl, carboxyl, anhydride, acyl, or ester functional groups. Preferred siliconized polyesters as used herein are further described in Applicants' international application, PCT/US2014/070096, filed Jan. 9, 2015.

If the binder system described herein includes siliconized polyester, the amount of siliconized polyester is preferably about 5 to 60 wt %, more preferably about 10 to 55 wt %, based on the total weight of the binder system.

The amount of the binder system in the coating composition described herein is preferably about 1 to 65 wt %, more preferably about 15 to 50 wt %, and most preferably about 20 to 45 wt %, based on the total weight of the coating composition. The type and amount of binder used in the composition will vary depending on the resin component(s) selected.

In an embodiment, the coating composition optionally further includes a crosslinker or crosslinking agent. The crosslinker may be used to facilitate cure of the coating and to build desired physical properties. When present, the amount of crosslinker will vary depending upon a variety of factors, including, e.g., the intended end use and the type of crosslinker. Typically, one or more crosslinkers will be present in the coating composition in an amount greater than about 0.01 wt-%, more preferably from about 5 wt % to about 50 wt %, even more preferably from about 10 wt % to about 30 wt %, and most from about 15 wt % to about 20 wt %, based on total weight of resin solids.

Suitable crosslinking agents may include, for example, aminoplasts, which are typically oligomers that are the reaction products of aldehydes, particularly formaldehyde; amino- or amido-group-carrying substances exemplified by melamine, urea, dicyandiamide, benzoguanamine and glycoluril; blocked isocyanates, unblocked isocyanates, or mixtures or combinations thereof. In some embodiments, an ultraviolet curing crosslinker or an electron-beam curing crosslinker may be suitable. Examples of suitable such crosslinkers may include 1,6-hexanediol diacrylate, 1,4-butanediol diacrylate, trimethylolpropane triacrylate, or mixtures thereof.

The coating composition described herein further includes one or more pigments. In an embodiment, the single layer coating system described herein provides a coating composition that includes a dispersion comprising (a) at least one pigment that is reflective in the near-infrared (NIR) region and (b) at least one pigment that is transparent in the near-infrared region. In a preferred aspect, the dispersion includes two or more pigments that are reflective in the NIR region. The pigments are preferably present as tint pastes or as a mixture of tint pastes.

In an embodiment, the at least one pigment or dispersion of two or more pigments that are reflective in the NIR region is present in an amount of at least 0.5 vol %, preferably at least 0.5 to 20 vol %, more preferably 10 to 15 vol %, based on the total pigment volume concentration (PVC) of the composition. In a preferred aspect, the at least one pigment or dispersion of two or more pigments that are reflective in the NIR region is present in an amount of at least 7.5 vol %, based on the total PVC of the composition. Without limiting to theory, it is believed that the optimal level of total solar reflectance is obtained when the at least one NIR-reflective pigment is present in an amount equal to or greater than at least 0.5 vol %, preferably at least 0.5 to 20 vol %, more preferably 10 to 15 vol %, based on the total PVC of the composition. In a preferred aspect, the at least one pigment or dispersion of two or more pigments that are reflective in the NIR region is present in an amount of at least 7.5 vol %, based on the total PVC of the composition.

The coating composition described herein includes one or more pigments in an amount such that the pigment-to-binder ratio (P/B) remains below the critical pigment volume concentration (CPVC), i.e. the minimum amount of binder needed to fill all the voids between pigment particles in a layer. Accordingly, in an aspect, the coating composition described herein has a P/B of preferably from 0.1 to 0.6, more preferably 0.2 to 0.4.

The types or colors of pigments or tint pastes are not limited, and may be selected according to a desired end use and/or a desired color or appearance. For example, the coating composition may include a dispersion that is a combination of black, red, green, and white tint pastes. Commercially available versions of the coating system described herein include, for example, but without limitation, FLUROPON or VALFLON, which are available in a wide range of colors across a broad color space.

The broad color space possible for the coating system described herein may be assessed in terms of a color scale or color system. Such color systems have three dimensions, in order to include all possible colors, and can be based either on a specific arrangement of predetermined colors or by identifying colors mathematically. In an aspect, the color system used herein is a mathematical scale, preferably the CIE color system. The CIE system is based on mathematical description of the light source, the object(s) and a standard observer. The light reflected or transmitted by an object is measured with a spectrophotometer or similar apparatus or instrument. The data can be mathematically reproduced as three-dimensional CIE color space using the L*a*b* equations, where L* represents lightness, a* represents redness-greenness, and b* represents yellowness-blueness. The quantities on the L*a*b* scale are calculated using equations known in the art.

In an embodiment, the color of the single layer coating system, described herein may be described using the L*a*b* scale. In an aspect, the coated article demonstrates color and sparkle across an expanded and nearly unlimited color space. The L* (brightness) values range from 0 (black) to 100 (white), a* ranges from 0 (green) to 100 (red), and b* ranges from 0 (blue) to 100 (yellow).

In a preferred aspect, the single layer coating system described herein is a dark colored coating system. By “dark color” is meant a coating that has an L* of between 0 and 50 on the L*a*b scale, preferably between 0 and 30. In some embodiments, the dark colored coating system may have L* values that are preferably at least 20, more preferably 30 units lower than the color of the substrate on which the single layer coating system is applied. In other embodiments, the dark colored coating systems may have L* values that are no more than 20 units, more preferably no more than 10 units lower than the color of the substrate, i.e. the substrate may have a dark color similar or identical to the single layer coating system described herein. In at least one embodiment, the single layer coating system described herein provides a coating composition that includes a dispersion comprising (a) at least one pigment that is reflective in the near-infrared (NIR) region and (b) at least one pigment that is transparent in the near-infrared region. In a preferred aspect, the dispersion includes a tint paste that has at least one black NIR-transparent pigment.

In an aspect, the NIR-transparent pigment, as part of the coating composition described herein, preferably has reflectance that increases with increasing wavelength along the electromagnetic spectrum. Specifically, the NIR-transparent pigment, as part of the coating composition described herein, preferably has a percent reflectance of at least about 10%, more preferably at least about 25%, at a wavelength of 750 nm and about 50%, more preferably about 60% or more, at a wavelength of 900 nm.

An exemplary NIR-transparent pigment is perylene, preferably a black perylene. Perylenes are organic pigments having a structure as shown below:

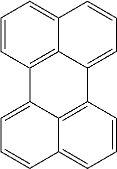 [SMILES: c1cc2cccc3c4cccc5cccc(c(c1)c23)c54]

Suitable examples of perylene include, without limitation, the PALIOGEN line (also known as SPECTRASENSE) of commercially available pigments (BASF). Other pigments known to be NIR-transparent may also be used, including, without limitation, other commercially available organic pigments, inorganic pigments, and combinations or mixtures thereof.

In an embodiment, the single layer coating system described herein demonstrates total solar reflectance (TSR) of at least about 25, preferably at least about 30, even more preferably at least about 45. As used herein, the term “total solar reflectance” refers to the measured and/or calculated amount of solar energy across the entire spectrum that is reflected away from an object or substrate. This correlates closely to the temperature that the object will reach when exposed to the sun for long periods of time, such as, for example, on a hot day in warmer climates.

Traditionally, dark colored coatings absorb energy in the visible range of the electromagnetic spectrum between 400 and 700 nm, providing a particular color appearance. But such coatings also absorb in the NIR region between 700 nm and 2500 nm. The absorbed near infrared radiation is converted to heat, causing increase in the temperature of a substrate, and any interior space defined by the substrate. In urban spaces, this phenomenon is called the “heat island effect,” and increases to the temperature above ambient conditions in nearby rural or suburban settings, and leads to increased energy consumption for cooling via air-conditioning, for example. Accordingly, various parts of buildings, such as roofs, siding, and the like, are coated with compositions that increase TSR, i.e. “cool coatings.” As the TSR of the coated article increases, the realized temperature in any interior space defined by the article is reduced, which leads to reduced energy consumption for cooling the space.

Conventionally, coatings with increased TSR employ a two-layer coating approach. A reflective basecoat (or primer) layer is used with a topcoat containing pigments that are only weakly absorbing in the NIR region and are either strongly backscattering (i.e. reflective) or capable of permeating NIR energy (i.e. transparent). In such systems, the topcoat must be darker than the basecoat, although the substrate itself is not limited. A two-layer system of this type is described in US20040191540, for example, incorporated herein fully by reference.

Conventional single layer coating systems with increased TSR are also known. Such systems use pigments that are weakly absorbing in the NIR region, and also require the use of substrates that are NIR-reflective, such as an aluminum substrate, for example.

Surprisingly, and in contravention of conventional practice in the art, the coating system described herein uses a single layer to achieve TSR of at least about 30. This is achieved by using a combination of NIR-reflective and NIR-transparent pigments. Moreover, this single layer coating system may be used with any substrate, including non-reflective substrates like glass, plastic, wood, concrete, composite materials, and combinations thereof, for example. In a preferred aspect, the single layer coating system described herein may be applied to a substrate or article intended to be part of a building such as a roof, siding, and the like. The coating system described herein is preferably a “cool coating.”

The single layer coating system described herein preferably demonstrates optimal weathering or weather resistance. By “weather resistance” is meant the resistance of the coating to degradation by exposure to UV radiation (i.e. sunlight) over an extended period of time. The test is typically performed using an unfiltered weatherometer, preferably a carbon arc unfiltered weatherometer, where the coating is exposed to unfiltered UV radiation for a fixed period of time (e.g. 500 hours, 1000 hours, and the like) intended to simulate direct exposure to sunlight for several years, and under more harsh conditions than conventional accelerated weather testing such as QUV testing, for example.

The coating composition may include other pigments, including, for example, titanium dioxide, silica, iron oxides of various colors, various silicates (e.g., talc, diatomaceous earth, asbestos, mica, clay, lead silicate, etc.), zinc oxide, zinc sulfide, zirconium oxide, lithophone, calcium carbonate, barium sulfate, and the like. Leafing and non-leafing metallic effect pigments may also be used. Organic pigments known to be stable at temperatures used to cure or bake coating compositions described herein may also be used.

The single layer coating system described herein comprises a coating composition that may optionally include other additives. These other additives can improve the application of the coating, the heating or curing of that coating, or the performance or appearance of the final coating. Examples of optional additives which may be useful in the composition include: cure catalysts, antioxidants, color stabilizers, slip and mar additives, UV absorbers, hindered amine light stabilizers, photoinitiators, conductivity additives, anti-corrosion additives, fillers, texture agents, degassing additives, flow control agents, mixtures and combinations thereof, and the like.

The coating compositions of the invention may be applied to substrates by any suitable conventional technique such as spraying, roller coating, dip coating and the like. The coating composition is applied in liquid form. After each coating composition is applied, the composition is cured or hardened by heating or baking according to methods well known in the art. Alternatively, each coating composition may be applied over the previous coating prior to cure (i.e. wet on wet application) and the coatings can then be cured or hardened by heating or baking by methods well known in the art. For example, for the compositions described herein, when used as coil coatings, high temperature baking for a time of preferably about 1 to 20 seconds, more preferably 5 to 10 seconds at a temperature of about 200° C. to 500° C., preferably about 300° C. to 400° C., more preferably 315° C. to 371° C. can be used. Typically, sufficient baking in coil coating applications is achieved when the actual temperature of the underlying metal reaches at least 350° C., and more preferably at least 200° C. For spray applications, longer dwell times of about 1 to 20 minutes, preferably 5 to 10 minutes are required, and baking temperatures of 200° C. to 300° C., preferably 200 to 250° C., more preferably 205° C. to 235° C. can be used. When the composition described herein is used as part of an architectural coating, cure is achieved by baking or drying at ambient temperature.

In general, the substrate and coating should be baked at a sufficiently high temperature for a sufficient time so that essentially all solvents are evaporated from the film and chemical reactions between the polymer and the crosslinking agent proceed to the desired degree of completion. The desired degree of completion also varies widely and depends on the particular combination of cured film properties required for a given application.

The coating composition described herein may be applied by a variety of methods known to those of skill in the art. In a preferred embodiment, the composition is applied to planar surfaces using a coil coating process. The coating is preferably applied as a thin film, with thickness in the range of preferably 0.1 to 5 mil (2.54 μm to 127 μm), more preferably 0.5 to 2 mil (12.7 μm to 50 μm), and even more preferably about 1 to 1.2 mil (25.4 μm to 30.48 μm).

The coating composition has utility in a multitude of applications. The coating composition of the invention may be applied, for example, as an intermediate coat, as a topcoat, or any combination thereof. In a preferred aspect, the coating composition described herein is applied as a topcoat. The coating composition may be applied to sheet metal such as is used for roofs, siding, architectural metal skins (e.g., gutter stock, window blinds, and window frames and the like) by spraying, dipping, or brushing, but is particularly suited for a coil coating operation where the composition is applied onto the sheet as it unwinds from a coil and then baked as the sheet travels toward an uptake coil winder. It is further contemplated that the coating composition of the invention may have utility in a variety of other end uses, including, industrial coating applications such as, e.g., appliance coatings; packaging coating applications; interior or exterior steel building products; HVAC applications; agricultural metal products; architectural coatings; wood coatings; etc. In a preferred aspect, the cured coating described herein is used as a “cool coating” for roofs, siding, and the like.

The single layer coating system described may be used with a variety of different substrates. Non-limiting examples of substrates that may benefit from having a coating composition of the invention applied on a surface thereof include hot-rolled steel, cold-rolled steel, hot-dip galvanized, electro-galvanized, aluminum, tin plate, various grades of stainless steel, and aluminum-zinc alloy coated sheet steel (e.g., GALVALUME sheet steel), glass, and the like.

The single layer coating system described herein may be used with a variety of different substrates. In one aspect, the substrate defines an interior surface. In another aspect, the substrate defines an exterior surface. In at least one embodiment, the coating described herein reduces the effect of infrared energy on the substrate, and reduces any increase in temperature of the interior or exterior space defined by the substrate. In an aspect, the interior or exterior space defined by a given substrate include, without limitation, at least part of a wall, roof, road, deck, railing, automotive surface, and the like, or combination thereof.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Missouri.

### TEST METHODS

Unless indicated otherwise, the following test methods were utilized in the Examples that follow.

### Total Solar Reflectance Test

The total solar reflectance (TSR) of coating compositions described herein is determined as follows. The solar reflectance of one or more test samples is measured using UV-Vis-NIR spectroscopy (PerkinElmer). The reflectance of the test sample is measured over the entire electromagnetic spectrum, from 2500 nm to 280 nm. Total solar reflectance is then calculated from software that integrates the measured reflectance values weighted by spectral irradiance Es (λ) of the sun with air mass 1.5 global tilt.

### Carbon Arc Accelerated Weather Testing

The accelerated weathering of coating compositions described herein is determined as follows. The weatherability of one or more test samples is determined using an unfiltered open-flame carbon arc weatherometer according to ASTM D3361/3361M. The samples are placed in the chamber and subjected to repeating cycles of 1 hour light on and 1 hour dark. The procedure is repeated until 200 light hours is achieved.

### EXAMPLE 1: Preparation of Conventional (Control) Topcoat Formulation

A conventional dark brown coil topcoat was formulated as a Control. The dark brown color was prepared by high speed dispersion using an air mixer after charging four NIR-reflective tint pastes in the types and amounts (based on the total weight of pigment) as shown in Table 1 below.

TABLE 1
Tint pastes in Control formulation

| Color | Type | Amount (wt %) |
|---|---|---|
| Black | Reflective | 43.7 |
| Green | Reflective | 37.1 |
| Red | Reflective | 5.9 |
| White | Reflective | 13.3 |

### EXAMPLE 2: Solar Reflectance of Control Formulation

The formulation from Example 1 was applied as a coating on three different substrates: glass, aluminum, and pre-primed GALVALUME at an average dry film thickness of approximately 20 μm. To cure the coating, coated substrates were heated in an oven set to 650 F (approx. 343° C.) until a peak metal temperature of 480 F (approx. 249° C.) was reached. Different dwell times were used for different substrates, i.e. 82 seconds for glass, 18 seconds for aluminum, and 40 seconds for pre-primed GALVALUME. The panels were then quenched in water and 2 in.×2 in. (5.08 cm×5.08 cm) square test samples were cut. Solar reflectance for each test sample was measured and total solar reflectance (TSR) calculated as described above. The TSR values for the Control formulation are shown in Table 2.

TABLE 2
Control TSR values (various substrates)

| Substrate | TSR |
|---|---|
| GALVALUME (pre-primed) | 28.2 |
| Bare Aluminum | 27.5 |
| Glass | 25.3 |

### EXAMPLE 3: Accelerated Weathering of Control Formulation

The formulation from Example 1 was applied as a coating on pre-primed GALVALUME at an average dry film thickness of approximately 20 μm and cured as described in Example 2. The panels were then quenched in water and 3 in.×6 in. (7.62 cm×15.24 cm) test samples were cut. Accelerated weathering was conducted as described above. Changes in CIE L*a*b* values and gloss were recorded and compared to a retain sample. The results for the Control formulation are shown in Table 3.

TABLE 3
Control Accelerated Weathering (200 light hours) Results

| Parameter | Value |
|---|---|
| ΔL | 5.48 |
| Δa | −0.30 |
| Δb | −0.58 |
| ΔE | 5.52 |
| % Gloss Retention | 27 |

### EXAMPLE 4: Preparation of Inventive Topcoat Formulation

Experimental topcoat formulations are prepared as described in Example 1, except that the reflective black tint paste is replaced by a NIR-transparent black pigment tint paste. This NIR-transparent tint paste is charged along with NIR-reflective pigments and mixed using high speed dispersion to make the topcoat formulation. The black transparent pigment and the other reflective pigments are used according to the color and the amount shown in Table 4 below.

TABLE 4
Tint Pastes in Inventive Formulation

| Color | Type | Amount (wt %) |
|---|---|---|
| Black | Transparent | 12.9 |
| Green | Reflective | 15.7 |
| Red | Reflective | 21.5 |
| White | Reflective | 49.9 |

### EXAMPLE 5. Solar Reflectance of Inventive Formulation

The formulation from Example 4 was applied as a coating on test panels of three different substrates: glass, aluminum, and pre-primed GALVALUME at an average dry film thickness of approximately 20 μm and cured as described in Example 2. The panels were then quenched in water and 2 in.×2 in. (5.08 cm×5.08 cm) square test samples were cut. Solar reflectance for each test sample was measured and total solar reflectance (TSR) calculated as described above. The TSR values for the Control formulation are shown in Table 5.

TABLE 5
Inventive TSR values (various substrates)

| Substrate | TSR |
|---|---|
| GALVALUME (pre-primed) | 40.2 |
| Bare Aluminum | 39.5 |
| Glass | 33.2 |

### EXAMPLE 6. Accelerated Weathering of Inventive Formulation

The formulation from Example 4 was applied as a coating on pre-primed GALVALUME at an average dry film thickness of approximately 20 μm and cured as described in Example 2. The panels were then quenched in water and 3 in.×6 in. (7.62 cm×15.24 cm) test samples were cut. Accelerated weathering was conducted as described above. Changes in CIE L*a*b* values and gloss were recorded and compared to a retain sample. The results for the Control formulation are shown in Table 6.

TABLE 6
Inventive Accelerated Weathering (200 light hours) Results

| Parameter | Value |
|---|---|
| ΔL | 5.65 |
| Δa | 0.92 |
| Δb | −0.64 |
| ΔE | 5.76 |
| % Gloss Retention | 38 |

### EXAMPLE 7. Preparation of Blended Inventive Topcoat Formulation

Blended experimental topcoat formulations are prepared as described in Example 4, except that both the reflective black tint paste and NIR-transparent black pigment tint paste are incorporated. The NIR-transparent tint paste is charged along with NIR-reflective pigments and mixed using high speed dispersion to make the topcoat formulation. The black transparent pigment and the other reflective pigments are used according to the color and the amount shown in Table 7 below.

TABLE 7
Tint Pastes in Blended Inventive Formulation

| Color | Type | Amount (wt %) |
|---|---|---|
| Black | Transparent | 11.6 |
| Black | Reflective | 6.6 |
| Green | Reflective | 14.8 |
| Red | Reflective | 20.0 |
| White | Reflective | 47.0 |

### EXAMPLE 8. Solar Reflectance of Blended Inventive Formulation

The formulation from Example 7 was applied as a coating on pre-primed GALVALUME at an average dry film thickness of approximately 20 μm and cured as described in Example 2. The panels were then quenched in water and 2 in.×2 in. (5.08 cm×5.08 cm) square test samples were cut. Solar reflectance for each test sample was measured and total solar reflectance (TSR) calculated as described above. The TSR values for the Control formulation are shown in Table 8.

TABLE 8
Blended Inventive TSR Values

| Substrate | TSR |
|---|---|
| GALVALUME (pre-primed) | 38.0 |

### EXAMPLE 9. Accelerated Weathering of Blended Inventive Formulation

The formulation from Example 7 was applied as a coating on pre-primed GALVALUME at an average dry film thickness of approximately 20 μm and cured as described in Example 2. The panels were then quenched in water and 3 in.×6 in. (7.62 cm×15.24 cm) test samples were cut. Accelerated weathering was conducted as described above. Changes in CIE L*a*b* values and gloss were recorded and compared to a retain sample. The results for the Control formulation are shown in Table 9.

TABLE 9
Blended Inventive Accelerated Weathering
(200 light hours) Results

| Parameter | Value |
|---|---|
| ΔL | 5.47 |
| Δa | 0.85 |
| Δb | −0.65 |
| ΔE | 5.57 |
| % Gloss Retention | 35 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. A single layer coating system, comprising:
a substrate;
a coating composition applied thereon, the composition comprising:
a binder resin component;
optionally, a crosslinking component; and
a dispersion comprising (a) at least one pigment that is reflective in the near-infrared (NIR) region and (b) at least one pigment that is transparent in the near-infrared region,
wherein the single layer coating system has total solar reflectance (TSR) of at least about 30.

2. A coating composition, comprising:
a binder resin component;
optionally, a crosslinking component; and
a dispersion comprising (a) at least one pigment that is reflective in the near-infrared (NIR) region and (b) at least one pigment that is transparent in the near-infrared region.

3. A method for improving the solar reflectance of a substrate, comprising:
providing a substrate;
applying on the substrate a coating composition comprising:
a binder resin component;
optionally, a crosslinking component; and
a dispersion comprising (a) at least one pigment that is reflective in the near-infrared (NIR) region and (b) at least one pigment that is transparent in the near-infrared region; and
curing the coating by heating,
wherein the cured coating has total solar reflectance (TSR) of at least about 30.

4. The system of claim 1, wherein the at least one pigment that is reflective in the NIR region is a tint paste including two or more tint pastes each having one or more colors, or mixtures thereof.

5. The system of claim 1, wherein the at least one pigment that is transparent in the NIR region is a tint paste including at least a black pigment.

6. The system of claim 1, wherein the at least one pigment that is transparent in the NIR region is a perylene pigment.

7. The system of claim 1, wherein the at least one pigment that is transparent in the NIR region is a black perylene pigment.

8. The system of claim 1, wherein the at least one pigment that is transparent in the NIR region demonstrates reflectance of at least 25% at a wavelength of 750 nm.

9. The system of claim 1, wherein the pigment that is transparent in the NIR region demonstrates reflectance of at least 50% at a wavelength of 900 nm, as part of the coating composition.

10. The system of claim 1, wherein the at least one pigment that is reflective in the NIR region is present in an amount of about 7.5 vol %, based on the total pigment volume concentration (PVC) of the composition.

11. The system of claim 1, wherein the substrate is a metal substrate selected from aluminum, steel, galvanized aluminum, or combinations thereof.

12. The system of claim 1, wherein the substrate is an inert material selected from glass, plastic, wood, concrete, composite materials, or combinations thereof.

13. The system of claim 1, wherein the substrate is not reflective.

14. The system of claim 1, wherein the substrate is unprimed.

15. The system of claim 1, wherein the substrate has a non-reflective primer applied thereon.

16. The system of claim 1, wherein the substrate defines an interior space.

17. The system of claim 1, wherein the substrate defines an exterior space.

18. The system of claim 1, wherein the coating reduces effect of infrared energy on the substrate and reduces increase in temperature of the interior space defined by the substrate.

19. The system of claim 1, wherein the coating reduces effect of infrared energy on the substrate and reduces increase in temperature of the exterior space defined by the substrate.

20. The system of claim 1, wherein the interior or exterior space defined by the substrate forms at least part of a wall, roof, road, deck, railing, automotive surface, or combination thereof.

21-23. (canceled)
